(19) United States
(12) Patent Application Publication
(10) Pub. No.: US 2026/0048490 A1
(43) Pub. Date: Feb. 19, 2026

(54) TORSION SPRING TENSIONING TOOL

(71) Applicant: Assa Abloy Entrance Systems AB, Landskrona (SE)

(72) Inventors: Toby BOETERS, Amersfoort (NL); Paul WENSING, Woudenberg (NL); Bert VAN DEN HAZEL, Putten (NL)

(21) Appl. No.: 19/104,016

(22) PCT Filed: Sep. 28, 2023
(86) PCT No.: PCT/EP2023/076989

§ 371 Date: Feb. 14, 2025

(30) Foreign Application Priority Data
Sep. 29, 2022 (SE) 2230315-0

(51) Int. Cl. B25B 27/30; E05D 13/00

(52) U.S. Cl. CPC B25B 27/306; E05D 13/1261; E05Y 2201/484; E05Y 2201/499

(57) ABSTRACT

Torsion spring tensioning tool (100) for tensioning a torsion spring of a counterbalancing mechanism of an overhead door, wherein the torsion spring tensioning tool (100) comprises a housing (80), a gear wheel arrangement (20) adapted to be mounted on a shaft of the counterbalancing mechanism, said gear wheel arrangement (20) comprising a gear wheel (21) rotatably arranged in the housing (80), the torsion spring tensioning tool (100) further comprising a gear mechanism (54) coupled to the gear wheel (21) for rotating said gear wheel (21). The gear wheel arrangement (20) comprises a first and second engaging arrangement (32, 60) arranged to be fixed relative to the gear wheel (21).

### TECHNICAL FIELD

Present invention relates to a torsion spring tensioning tool for tensioning a torsion spring of a counterbalancing mechanism of an overhead door.

### BACKGROUND

In overhead doors, a counterbalancing mechanism is usually used to counterbalance the weight of the door in order to reduce the force required for operating the door. This reduces the human effort or the motor power required to open the door. The counterbalancing mechanism usually comprises one or two torsion springs arranged around a shaft. One end of the torsion spring is fixed e.g. by a stationary cone. The other end of the torsion spring usually comprises a winding cone that is securable to the shaft by tightening screws and sometimes by a key. The winding cone is commonly provided with four radial holes for winding of the spring either by hand operated rods or by a tensioning tool for tensioning of the spring by rotation of the torsion spring before securing the winding cone to the shaft. In some cases the winding cone may be provided with a set of splines for the same purpose.

One type of tensioning tool is described in U.S. Pat. No. 8 616 093, where a torsion spring winding assembly comprises a coupling shaft structure for installation on a torsion spring winding cone, a gearbox assembly installed onto the coupling shaft structure and a sliding lever arm attached to the gearbox assembly and positioned against the inside of a garage door frame structure. The coupling shaft structure is comprised of two body halves fitted together by guiding pins and mating holes. Each body half has a winding hub portion. Each winding hub portion has two locking bolts hand tightened into winding bar slots on the winding cone. The gearbox assembly has a gearbox end cap that is pivotable into an open position. The gearbox end cap fits around the coupling shaft structure. The gearbox assembly is securable to the coupling shaft structure. A screw gun applies a rotational force to the gearbox assembly. Known tensioning tools are complicated to mount on the shaft of the counterbalancing mechanism and require a large number of operations to connect the tensioning tool to the torsion spring.

There are tools available on the market; however, such tools are not very robust relative the high torque of the torsion spring. Tensioning tools according to prior art also comprises several parts that are complex, weak and sensitive to wear. Also, service personnel are often required to do maintenance on different brands and types of doors which requires a large number of tools for adjusting different shafts and winding plugs.

In order to address the above referenced issues a torque tensioning tool involving the use of different adapters for allowing service personnel to service different brands and types of door a new torque tool was developed. The torque tool is disclosed in WO 2022117574 A1. The present inventors have however identified that the mounting of such adapters is cumbersome and makes the torque tool more complex to use as well as bulkier which may prevent tensioning of the torsion spring if there is limited room available next to the door.

Thus, there exists a need for an improved tensioning tool.

### SUMMARY

According to an aspect, a torsion spring tensioning tool for tensioning a torsion spring of a counterbalancing mechanism of an overhead door is provided. The torsion spring tensioning tool comprises a housing and a gear wheel arrangement adapted to be mounted on a shaft of the counterbalancing mechanism. The gear wheel arrangement comprises gear wheel rotatably arranged in the housing.

The torsion spring tensioning tool further comprises a gear mechanism coupled to the gear wheel for rotating said gear wheel.

The gear wheel arrangement comprises a first engaging arrangement and a second engaging arrangement. The first and second engaging arrangement are each arranged to be fixed relative to the gear wheel.

The first engaging arrangement is adapted to engage a first corresponding engagement interface associated with a first type of shaft and counterbalancing mechanism. The first engaging arrangement is adapted to transmit a rotational movement from the gear wheel to the torsion spring of said first type of counterbalancing mechanism.

The second engaging arrangement is adapted to engage a second corresponding engagement interface associated with a second type of shaft and counterbalancing mechanism. The second engaging arrangement is adapted to transmit a rotational movement from the gear wheel to the torsion spring of said second type of counterbalancing mechanism.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

Embodiments of the invention will be described in the following; reference being made appended drawings which illustrate non-limiting examples of how the inventive concept can be reduced into practice.

FIG. 1 depicts a torsion spring tensioning tool according to a first embodiment in a side view.

FIG. 2 depicts the tensioning tool according to the first embodiment in a front view.

FIG. 3 depicts a portion of the tensioning tool according to the first embodiment in a perspective view.

FIG. 4 depicts the tensioning tool according to the first embodiment without a part of the housing in a back perspective view.

FIG. 5 depicts the tensioning tool according to the first embodiment without a part of the housing and torque receiving arrangement in a back perspective view.

FIG. 6 depicts a first engaging arrangement of the tensioning tool according to the first embodiment in a perspective view.

FIG. 7 depicts a part of the second engaging arrangement of the tensioning tool according to the first embodiment in a perspective view.

FIG. 8 depicts a part of the second engaging arrangement of the tensioning tool according to the first embodiment in a perspective view.

FIG. 9 depicts a part of the second engaging arrangement of the tensioning tool according to the first embodiment in a perspective view.

FIG. 10 depicts a torsion spring tensioning tool according to a second embodiment in a side view.

FIG. 11 depicts the tensioning tool according to the second embodiment in a front view.

FIG. 12 depicts a portion of the tensioning tool according to the second embodiment in a perspective view.

FIG. 13 depicts a torsion spring tensioning tool and kit according to an embodiment.

FIG. 14 depicts an adapter unit according to an embodiment in a perspective view.

FIG. 15 depicts an adapter unit according to an embodiment in a top view.

FIG. 16 depicts a torsion spring tensioning tool and kit according to an embodiment.

FIG. 17 depicts an adapter unit according to an embodiment in a perspective view.

FIG. 18a-b depicts a mounting bracket for mounting to a torsion spring tensioning tool.

### DETAILED DESCRIPTION

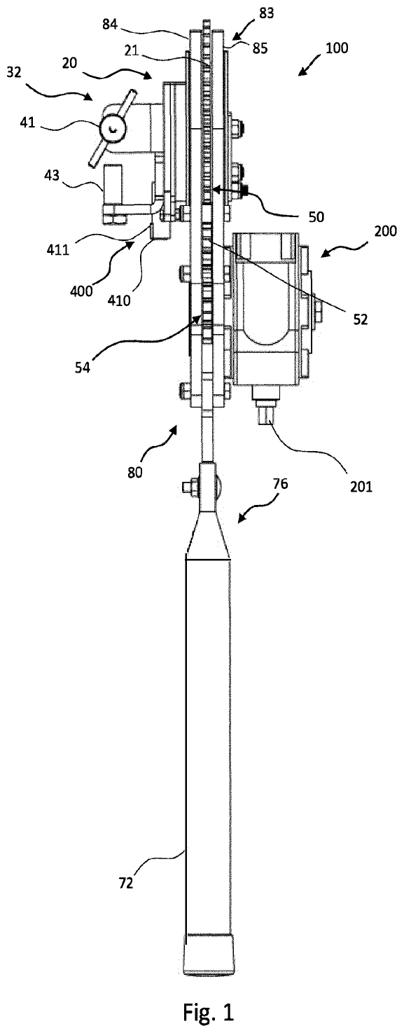

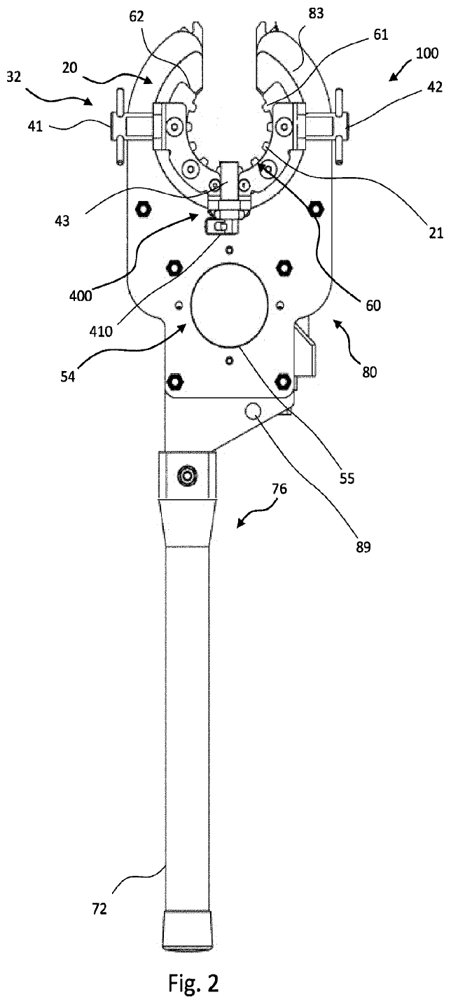

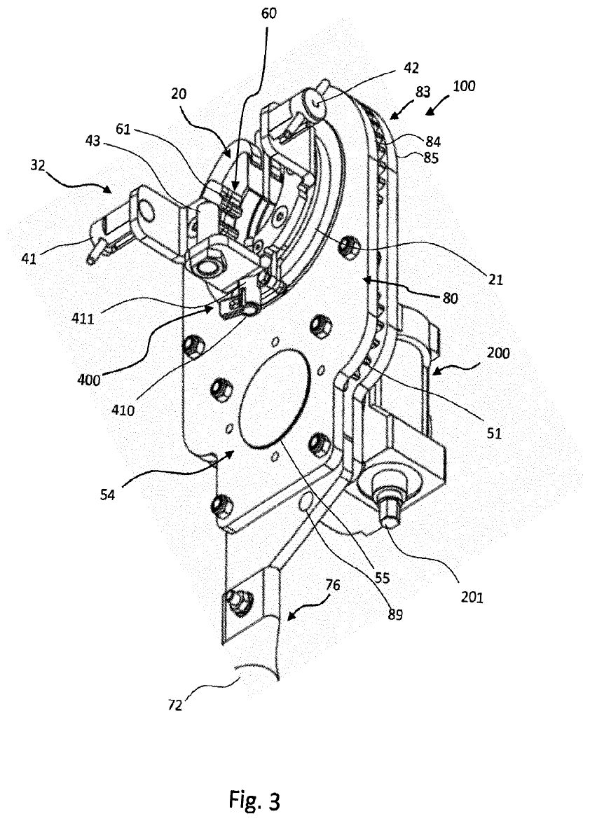

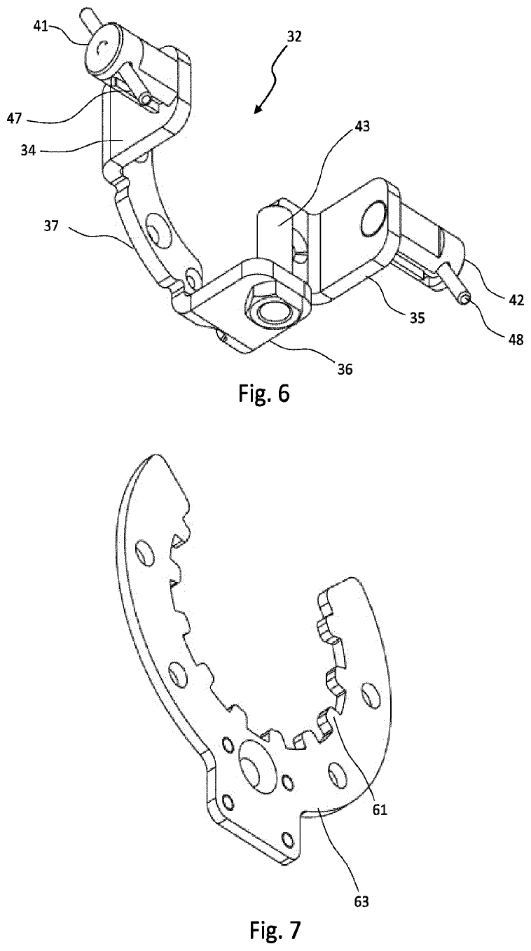

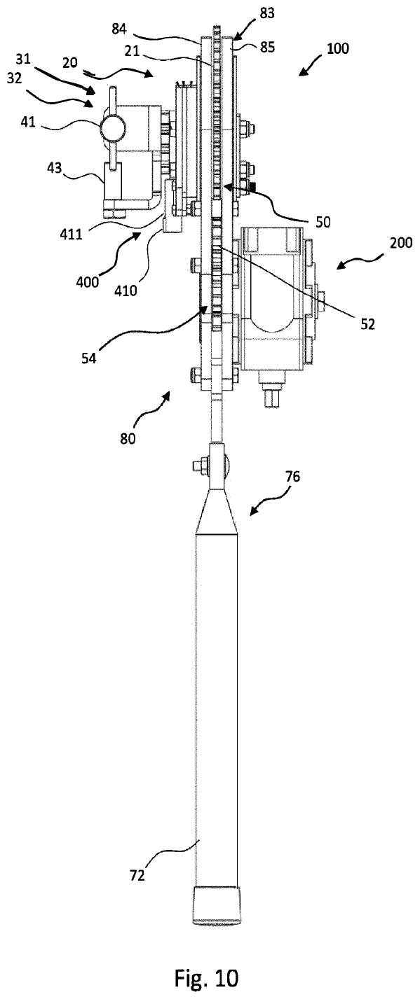

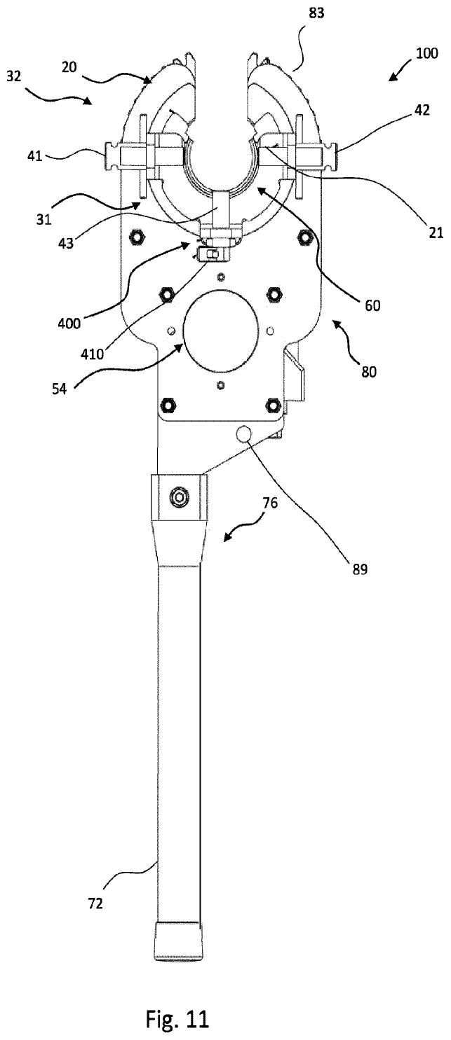

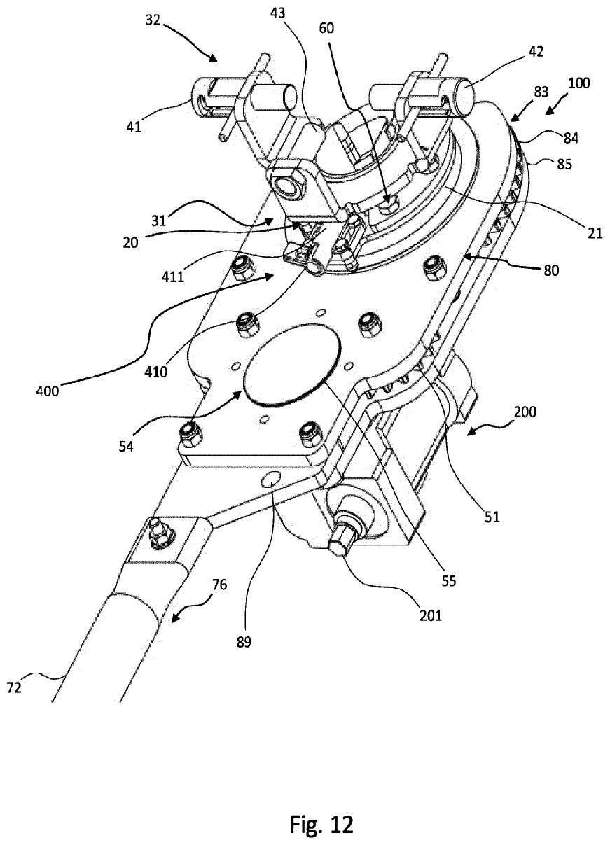

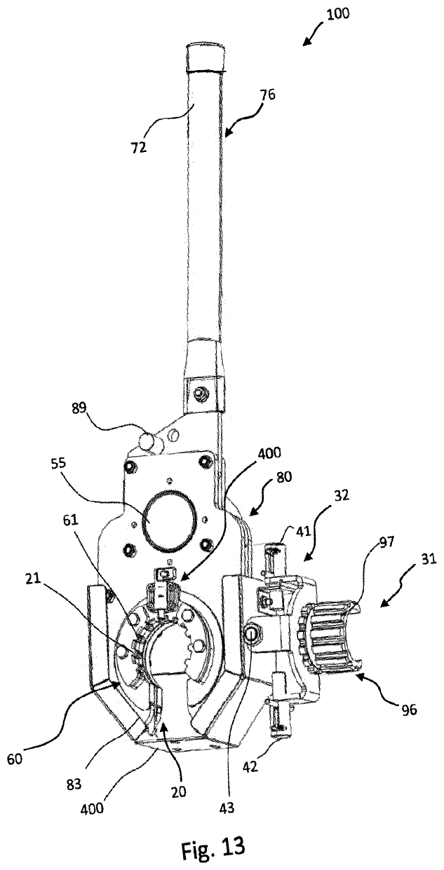

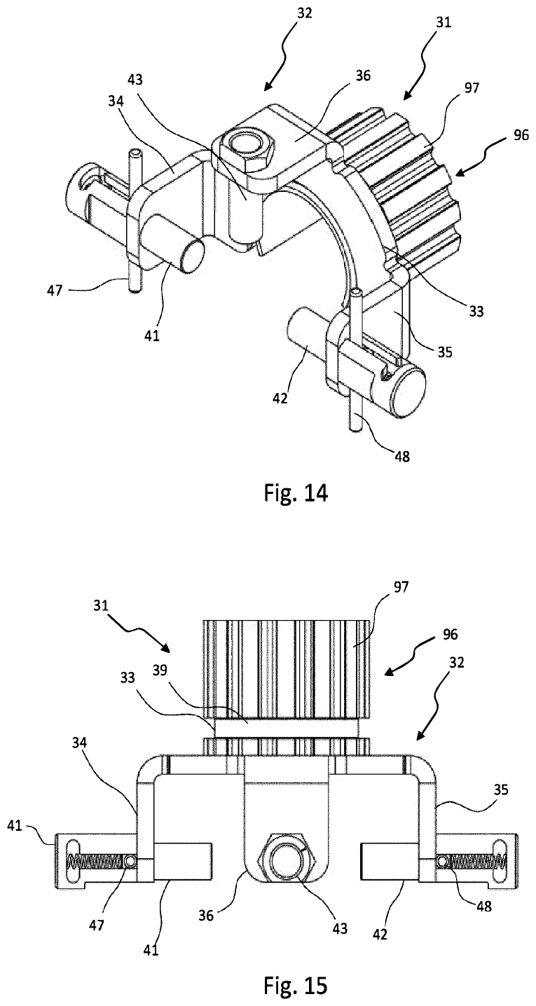

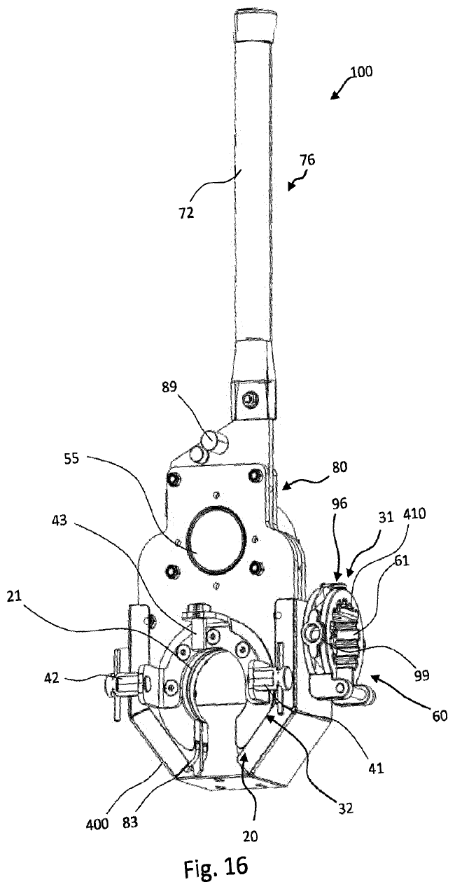

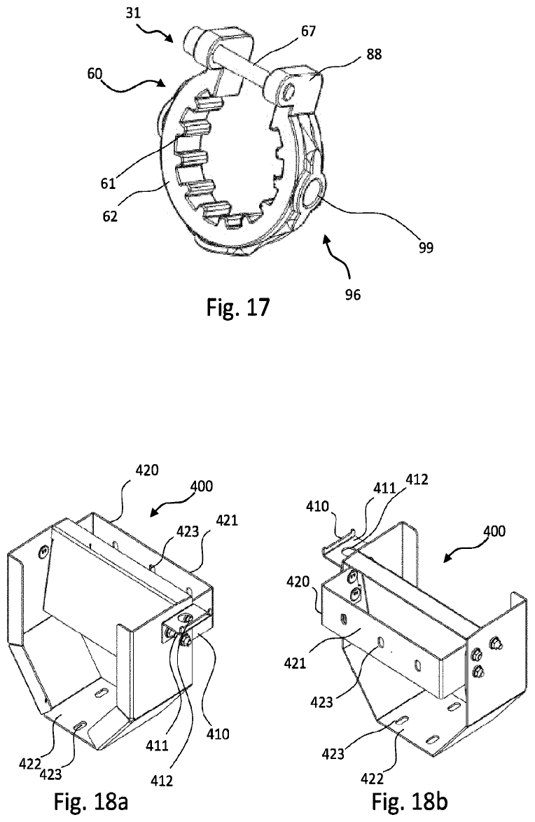

A spring tensioning tool 100 according to a first embodiment for tensioning a torsion spring of a counterbalancing mechanism of an overhead door is depicted in FIGS. 1-5. Details of the tensioning tool are depicted in FIGS. 6-9. A spring tensioning tool 100 according to a second embodiment for tensioning a torsion spring of a counterbalancing mechanism of an overhead door is depicted in FIGS. 10-12. A spring tensioning tool according to a third embodiment and a spring tensioning tool kit are depicted in FIG. 13. Details of the tensioning tool according to the second and third embodiment are depicted in FIGS. 14-15. A spring tensioning tool according to a fourth embodiment and a spring tensioning tool kit are depicted in FIG. 16. Details of the tensioning tool according to the fourth embodiment are depicted in FIG. 17. FIG. 18a-b depicts details of the spring tensioning tool kit.

The torsion spring tensioning tool 100 comprises a housing 80 and a gear wheel arrangement 20. The gear wheel arrangement 20 is adapted to be mounted on a shaft of the counterbalancing mechanism.

The gear wheel arrangement 20 comprises a gear wheel 21. The gear wheel 21 is rotatably arranged in the housing 80.

The torsion spring tensioning tool 100 further comprises a gear mechanism 54. The gear mechanism 54 is coupled to the gear wheel 21 for rotating said gear wheel 21.

The gear wheel arrangement 20 further comprises two engaging arrangements. The gear wheel arrangement hence comprises a first engaging arrangement 32 and a second engaging arrangement 60. The first engaging arrangement may be arranged to be fixed relative to the gear wheel 21. Preferably, the first engaging arrangement 32 is fix relative to the gear wheel 21. Similarly, the second engaging arrangement may be arranged to be fixed relative to the gear wheel 21. Preferably, the second engaging arrangement 60 is fix relative to the gear wheel 21.

In one embodiment, the first engaging arrangement 32 may be fixed to the gear wheel 21. In one embodiment, the second engaging arrangement 60 may be fixed to the gear wheel 21.

The gear mechanism allows for tensioning of the torsion spring with the tool in a simple manner by rotation of the gear mechanism. Thus, a more safe and user friendly tensioning may be achieved.

In order to accommodate a tool which is versatile and can be used for several types of overhead doors, the first and second engaging arrangement may be intended to tension different types of counterbalancing mechanism (torsion springs of counterbalancing mechanisms) corresponding to doors made by different manufacturers, having different dimensions etc.

Thus, the first engaging arrangement 32 is adapted to engage a first corresponding engagement interface associated with a first type of shaft and counterbalancing mechanism, i.e. a shaft of a first type of counterbalancing mechanism. The first engaging arrangement 32 is adapted to transmit a rotational movement from the gear wheel 21 to the torsion spring of said first type of counterbalancing mechanism. The rotational movement accordingly provides a tensioning torque for the torsion spring.

Correspondingly, the second engaging arrangement 60 is adapted to engage a second corresponding engagement interface associated with a second type of shaft and counterbalancing mechanism, i.e. a shaft of a second type of counterbalancing mechanism. The second engaging arrangement 60 is adapted to transmit a rotational movement from the gear wheel 21 to the torsion spring of said second type of counterbalancing mechanism. The rotational movement accordingly provides a tensioning torque for the torsion spring.

Thus, the first engaging arrangement 32 is adapted to engage a first corresponding engagement interface associated with a first type of shaft. The first type of shaft may thus be associated with a first type of overhead door.

The second engaging arrangement 60 is adapted to engage a second corresponding engagement interface associated with a second type of shaft. The second type of shaft may thus be associated with a second type of overhead door.

Having a first and second engaging arrangement allows the same tool to be used for a large number of overhead doors. Furthermore, the number of adapters required to accommodate for different types of shafts can be reduced or the adapters may even be omitted completely.

In addition, the dual engaging arrangements allows for a more space-efficient tool, since the tool does not need to be dimensioned to accommodate movable parts in order to secure multiple different types of adapters. The potential emitting of the movable parts further allows for a more robust and safe tool.

In order to allow for an even more compact tensioning tool, the first engaging arrangement 32 and the second engaging arrangement 60 may be coaxially arranged. Hence, the first engaging arrangement 32 and the second engaging arrangement 60 may be arranged along the same axis. This allows for a tool which is capable of tensioning the torsion spring even in cases where there is a limited space available next to the door.

The first engaging arrangement 32 and the second engaging arrangement 60 may be coaxial along an axis extending orthogonally to the gear wheel 21. Said axis may further be aligned with the shaft of the overhead door when the torsion tool is mounted to said shaft.

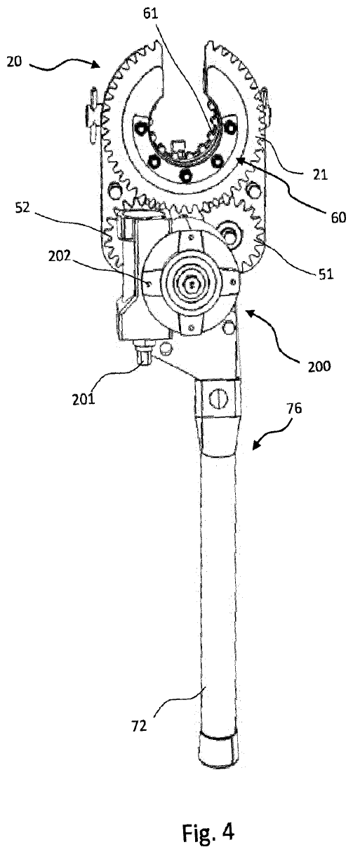

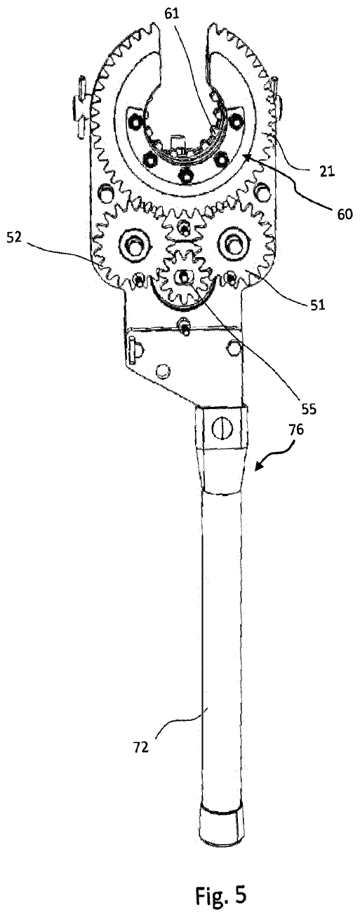

Preferably and most clearly depicted in FIGS. 4 and 5, the gear mechanism 54 may comprise a plurality of cogged wheels 51, 52 engaging the gear wheel 21. The plurality of cogged wheels provides additional support for the gear wheel even when the gear wheel is subjected to a large torque. This is particularly advantageous due to the large torques present in the counterbalancing mechanism.

The gear wheel 21 comprises teeth along the circumference of said gear wheel 21. Said teeth extends radially outwards from a center of the gear wheel 21. Said teeth may extend radially outwards from a rotational axis of said gear wheel 21. In one embodiment, the gear wheel 21 may comprise a gear rim. The gear rim is arranged along the circumference of the gear wheel. The gear rim may comprise the teeth. The term gear rim herein refers to a toothed surface. The toothed surface consequently forms the engagement interface of a gear.

Preferably, the gear wheel 21 is formed as a partial ring gear wheel, i.e. a section of a full ring gear wheel. Thus, the gear wheel 21 may be a non-continuous ring gear wheel provided with an opening along the gear rim.

In one embodiment, the gear wheel 21 is formed as a partial ring wheel and the housing 80 has an open end such that the first engaging arrangement 32 or the second engaging arrangement 60 can be brought into engagement with the first or second corresponding engagement interfaces, respectively, from a direction extending orthogonally to the shaft, e.g. in the same plane as the gear wheel 21.

In one embodiment, the gear wheel 21 is positioned between sliding bearings provided in the housing 80. The sliding bearings holds the gear wheel 21 in position while allowing for the gear wheel 21 to rotate. Hence, the gear wheel 21 is allowed to rotate relative the housing while being held fixed in an axial direction (relative to the shaft).

The gear wheel 21 and the housing 80 are adapted such that the first engaging arrangement 32 can be brought into engagement with the first corresponding engagement interface and the second engaging arrangement 60 can be brought into engagement with the second corresponding engagement interface from a direction extending orthogonally to the shaft.

The ring wheel shape accommodates use of the tool together with shafts of different dimensions. Furthermore, the possibility of bringing the engaging arrangements into engagement with the shaft in a direction orthogonal to the shaft allows use of the tool even for doors arranged in tight spaces.

The tensioning tool may further comprise a handle 75. The handle facilitates mounting of tensioning tool on the shaft of the counterbalancing mechanism and operation of the tensioning tool since the housing can easily be moved by hand during mounting and easily be kept by hand during operation. The handle 75 is coupled to the housing 80. The handle 76 comprises an elongated handle element 72.

As aforementioned, the torsion spring tensioning tool 100 comprises a housing 80. The gear wheel 21 is rotatably arranged in the housing 80. The housing 80 comprises a flange 83. The flange 83 comprises a first lip 84 arranged on one axial side of the gear wheel 21 and a second lip 85 arranged on the other axial side of the gear wheel 21. The gear wheel 21 is thus rotatably arranged in the flange 83, i.e. between the first lip 84 and the second lip 85. The first lip 84 and the second lip 85 may each be provided with a sliding bearing clamping the gear wheel 21 and allowing for rotation of said gear wheel 21.

The flange 83 may thus comprise a first and second curved arm extending on opposite sides of the gear wheel 21. The first and second curved arm may be arranged at a distance from each other to form the opening allowing for the shaft to pass through the housing 80.

The housing 80 may further include an aperture for receiving the shaft. The first and second engaging arrangement may be arranged such that the engagement interface associated with the shaft engages the first or second engaging arrangement upon the shaft being received in said aperture. The aforementioned opening may provide a passage into said aperture. The engaging members of the first and second engaging arrangement, which will be described further with reference to FIGS. 6 to 9, may be arranged to face the center of said aperture. The engaging members are thus arranged to engage the engagement interface when the shaft is received in the aperture.

As most clearly depicted in FIGS. 4 and 5, the gear mechanism 54 may rotate the gear wheel 21 during operation of the tensioning tool 100. Since the first engaging arrangement 32 and the second engaging arrangement 60 are arranged to be fixed relative to the gear wheel 21 and either the first or second engaging arrangement in operation is connected to the torsion spring of the counterbalancing mechanism and transmits a rotational movement from the gear wheel 21 to the torsion spring, the torsion spring is wound when the gear wheel 21 is rotated. Depending on the direction of the rotation of the gear wheel 21, the torsion spring is either wound up and thereby tensioned or unwound and thereby relaxed, the latter implying that the tension of the torsion spring is reduced.

The gear mechanism provides rotational support to the gear wheel, whereby a more robust tensioning tool is achieved. Further, a safer tensioning is achieved due to the tool being less susceptible to the large torque exerted to the tool by the torsion spring.

The gear mechanism 54 may be adapted to be rotated by an external drive unit. An external drive unit may be connectable to a rotation member 55 of the gear mechanism 54. Thereby, the rotation member 55 is driven by the external drive unit. The rotation member 55 is rotated by the external drive unit. The rotation member 55 may be in the form of a gear wheel.

In one embodiment, the gear mechanism 54 may comprise a torque receiving arrangement 200. The torque receiving arrangement 200 comprises a driven member 201. The driven member 201 is adapted to engage a driving member of an external drive unit for transfer of torque to the gear 21.

The torque receiving arrangement may comprise a transmission element 202. The transmission element 202 may be a gear wheel. The transmission element is rotatably arranged in a bearing.

The transmission element 202 is connected to the driven member 201 and the rotation member 55. The transmission element 202 is arranged to transfer torque from the driven member 201 to the gear wheel 21.

In one embodiment, the transmission element 202 is arranged to be fix relative the rotation member 55. The rotation member 55 may be coaxial to the transmission element 202.

Thus, the transmission element 202 rotates the rotation member 55. The rotation member 55 rotates the gear wheel 21 (preferably via other gears of the gear mechanism). The gear wheel arrangement 20 with the gear wheel 21 is connected to the torsion spring by means of the first engaging arrangement 32 or the second engaging arrangement 60. Thereby, the torsion spring is tensioned by the external drive unit.

The external drive unit may be a screw gun or a drilling machine. The gear mechanism 54 and in particular the rotation member 55 is adapted to be connected to a screw gun or drilling machine.

Preferably, the torque receiving arrangement 200 is provided as a worm gear mechanism. The driven member 201 is connected to a worm gear shaft and the transmission element 202 may be connected to said worm gear shaft. The worm gear mechanism allows for a cheaper and more compact manner of transferring torque to the gear wheel without sacrificing performance.

Further referencing FIGS. 4 and 5, the gear mechanism 54 comprises a plurality of cogged wheels 51, 52.

The plurality of cogged wheels 51, 52 is in engagement with the gear wheel 21 for providing rotational support for said gear wheel 21 and transferring torque to the gear wheel 21. The plurality of cogged wheels 51, 52 may be rotatably coupled to the housing 80 and the gear wheel 21 to function as a reduction gearing. Accordingly, the plurality of cogged wheels 51, 52 may be considered a reduction gearing.

The plurality of cogged wheels 51, 52 50 may be rotatably arranged in the housing 80.

The plurality of cogged wheels 51, 52 may be distributed along the circumference of gear wheel 21. As depicted in FIG. 5, the plurality of cogged wheels may comprise a first cogged wheel 51 and a second cogged wheel 52. The first and second cogged wheel may be distributed along a first half of the circumference of the gear wheel 51. Hence, the first cogged wheel 51 and the second cogged wheel 52 may be arranged on opposite sides of the gear wheel 21 relative a rotation axis of the gear wheel 21. The first cogged wheel 51 may thus be arranged on a first side of the rotation axis and the second cogged wheel 52 may be arranged on a second side of the rotation axis, the second side being opposite to the first. This ensures sufficient support for the gear wheel even when the tool subjected to large torques.

The first and second cogged wheel 51, 52 may each be connected to, e.g. engage, the rotation member 55. In the depicted embodiment, the rotation member 55 is arranged between the first and second cogged wheel.

Each of the cogged wheels 51, 52 are rotatably arranged in the housing 80. Each of the cogged wheels 51, 52, is connected to the housing by means of shafts arranged in the housing 80.

The first engaging arrangement 32 may comprise a plurality of engaging members 41, 42, 43. The engaging members 41, 42, 43 are adapted to engage a set of corresponding engagement members of the first corresponding engagement interface.

The second engaging arrangement 60 may comprise a plurality of engaging members 60. The engaging members 60 are adapted to engage a set of corresponding engagement members of the second corresponding engagement interface.

FIG. 6 depicts the first engaging arrangement in further detail. The first engaging arrangement 32 is adapted to be connected to the torsion spring of the counterbalancing mechanism. This may be performed by connecting the first engaging arrangement 32 to the shaft of the counterbalancing mechanism which in turn is connected to said spring. The engaging arrangement 32 is adapted to be connected to a winding cone, which is connected to the torsion spring. The winding cone may be formed as a part of the shaft of the counterbalancing mechanism.

The first engaging arrangement 32 comprises a plurality of engaging members 41, 42, 43. The engaging members 41, 42, 43 are adapted to engage corresponding engagement members of the shaft of the counterbalancing mechanism.

The engaging members 41, 42, 43 may be radially connectable to the torsion spring. The engaging members are radially connectable to a winding cone, which is connected to the torsion spring and forms a part of the shaft of the counterbalancing mechanism. The winding cone comprises the corresponding engagement members of the shaft of the counterbalancing mechanism.

The corresponding engagement members may be holes. Preferably, the corresponding engagement members may be radial holes.

Accordingly, the engaging members 41, 42, 43 may be radially insertable into the corresponding engagement members (radial holes) in the winding cone. A winding cone usually comprises several radial holes, commonly four radial holes. The engaging members 41, 42, 43 may be radially insertable in at least a plurality of the radial holes of the winding cone. In operation, the engaging members 41, 42, 43 transmits a rotational movement from the gear wheel 21 to the torsion spring.

In one embodiment, the first engaging arrangement 32 may comprise at least three engaging members 41, 42, 43. The engaging members 41, 42, 43 may be substantially evenly distributed along the gear wheel 21.

Preferably, the plurality of engaging members 41, 42, 43 are in the form of pins. In one embodiment, the plurality of engaging members 41, 42 ,43 of the first engaging arrangement comprises one or more movable pins 41, 42.

The plurality of engaging members 41, 42, 43 may comprise an adjustable pin or a fix pin 43 and at least one retractable pin 41, 42. The adjustable pin may be a threaded adjustable pin.

The fix or adjustable pin 43 may be arranged 90 degrees from each of a first and second retractable pin 41, 42, e.g. in a plane parallel to the gear wheel 21. The adjustable pin or fix pin 43 may be arranged 90 degrees from each of the first and second retractable pin 41, 42 in a plane parallel to the gear wheel 21. The first retractable pin 41 may be opposite to the second retractable pin 42 relative to the gear wheel 21.

The first and second retractable pin 41, 42 may be spring loaded such that said first and second retractable pin 41, 42 is biased against the corresponding engagement members of the shaft.

The retractable pins 41, 42 may each be movably mounted in a sleeve. Said sleeve may be arranged with an elongated recess extending in a radial direction relative to the gear wheel. To allow for retraction, the retractable pin 41, 42 may be provided with an adjustment element 47, 48 protruding through the elongated recess. Rotation of the adjustment element 47, 48 along the elongated recess releases the adjustment element from a locking portion of the elongated recess thus causing movement of the retractable pin 41, 42, i.e. relative movement relative to the gear wheel 21, from a retracted position to an engaged position.

The engaging arrangement 32 comprises a plurality of distance members 34, 35, 36 adapted to arrange the gear wheel 21 remote from the torsion spring. The distance member 34, 35, 36 are also adapted to arrange the gear wheel 21 remote from the winding cone of the torsion spring. Thereby, the gear wheel 21 is arranged remote from the torsion spring such that there is a distance between the gear wheel 21 and the torsion spring as well as the winding cone. The distance between the gear wheel 21 and the torsion spring as well as the winding cone enables mounting of a key on the shaft, which key rotationally locks the winding cone on the shaft.

The key is insertable into a key groove formed in the shaft of the counterbalancing mechanism and a key groove formed in the winding cone. The engaging members 41, 42, 43 are each connected to a respective distance member 34, 35, 36 such that the engaging members 41, 42, 43 are arranged remote from the gear wheel 21. The distance members 34, 35, 36 extends axially from the gear wheel 21. The engaging members 41, 42, 43 each extends radially from the respective distance member 34, 35, 36.

In one embodiment, the engaging members 41, 42, 43 may each extend radially from a distal end of their respective distance member, which distal end is opposite to a proximal end attached to the gear wheel. The distance members 34, 35, 36 may be elongated distance members 34, 35, 36. Each distance member 34, 35, 36 and corresponding engagement member 41, 42, 43 may together have an L-shape.

The first engaging arrangement 32 may comprise a fixating plate 37. Said fixating plate 37 is attached to the gear wheel 21. The distance members 34, 35, 36 may be formed as protrusions extending axially from said fixating plate 37. A first main surface of the fixating plate 37 may be in contact with the gear wheel 21. The distance members 34, 35, 36 may protrude axially from a second main surface of the fixating plate, said second main surface being opposite to the first main surface.

The second engaging arrangement 60 is depicted in further detail in FIGS. 7 to 9. Similar to the first engaging arrangement, the second engaging arrangement 60 may comprise a plurality of engaging members 61. The plurality of engaging members 61 is adapted to engage corresponding engagement members of the shaft of the counterbalancing mechanism.

The second engaging arrangement generally functions similar to the first engaging arrangement, with the exception of the design of the engaging members accommodating for engaging shafts of different overhead doors, i.e. shafts with different engagement interfaces.

The plurality of engaging members 61 of the engaging arrangement may form at least one cogged surface. The at least one cogged surface is adapted to engage corresponding engagement members in the form of splines of the shaft of the counterbalancing mechanism. The cogged surface may be adapted to engage with splines of the shaft of the counterbalancing mechanism. Thereby transfer of torque from the engaging arrangement to the torsion spring of the counterbalancing mechanism, e.g. a shaft of the counterbalancing mechanism, may be achieved. The cogged surface herein references a toothed surface with teeth intended to engage splines of the shaft, i.e. splines of the engagement interface of the shaft.

Thus, the plurality of engaging members 61 of the second engaging arrangement 60 forms at least one cogged surface adapted to engage corresponding splines of the second corresponding engagement interface.

The cogged surface may be adapted to fit a particular counterbalancing mechanism with a corresponding set of splines. This mitigates the need for an adapter plate since the alignment between the engaging arrangement and the shaft of the counterbalancing mechanism is easily achieved by the tight engagement between the splines and cogged surface. Thereby, the implementation of such an engaging arrangement allows for a tool that is easier to use. In addition, it achieves a tool that requires less space for the operation of tensioning of the torsion spring since the tool will be thinner without the adapter plate.

The at least one cogged surface may form at least a partial ring gear rim. Preferably, the at least one cogged surface form a partial ring gear rim. The cogs may protrude radially from the rim. In the depicted and preferred embodiment, the at least one cogged surface forms a partial ring gear rim to allow a user to engage cogged surface and the splines of the shaft of the counterbalancing mechanism. A partial ring gear rim herein refers to a gear rim formed as an arc section. Although not preferred, the cogged surface may in some embodiments form a full ring gear rim corresponding to the shaft of the counterbalancing mechanism.

The cogs of the cogged surface may be adapted to extend radially, i.e. radially towards the shaft when the tool is mounted to said shaft.

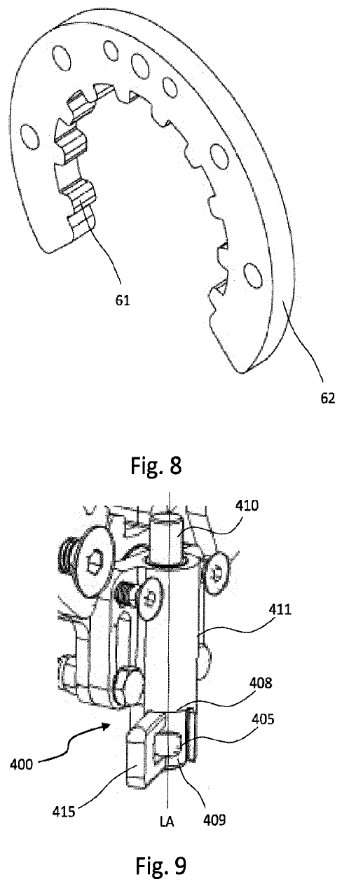

In one embodiment, the second engaging arrangement 60 comprises an engaging element 62 adapted to engage the corresponding splines of the second corresponding engagement interface. The engagement element 62 is depicted in FIG. 8.

In one embodiment, the engaging element 62 may be provided as a partial ring gear. The at least one cogged surface may thus form a gear rim of said partial ring gear 62. Alternatively, the engaging element 62 may be provided as a plate member with teeth forming the cogged surface.

As aforementioned, the engaging element 62 may be provided with engaging members 61. The cogged surface may accordingly form a gear rim of the engaging element 62. Preferably the engaging element 62 is inwardly facing, e.g. forms an internal gear rim. The cogs of the cogged surface provided on the fixating plate may be adapted to extend radially, i.e. radially towards the shaft when the tool is mounted to said shaft.

The second engaging arrangement may as depicted in FIGS. 7 to 9 be comprised of multiple parts.

FIG. 7 depicts a mounting plate 63. The mounting plate 63 may be mounted to the gear wheel 21. In one embodiment, the mounting plate 63 may be provided with engaging members. Hence, the mounting plate may in one embodiment be comprised in the second engaging arrangement 60. Similar to engaging element 62, the mounting plate 63 may thus be provided with at least one cogged surface adapted to engage corresponding splines of the second corresponding engagement interface. The mounting plate 63 is preferably arranged coaxially to the engaging element 62. The mounting plate 63 may comprise means for fastening the latching mechanism 400 which will be described with reference to FIG. 9. The mounting plate may however also be provided without any engaging members, thus not forming a part of an engaging arrangement of the tool.

Referencing FIG. 9, the torsion spring tensioning tool 100 may comprise a latching mechanism, i.e. is further provided with an engagement member in the form of a latching pin 410 of a latch mechanism 400.

The latching mechanism may be utilized for fixating an adapter unit which will be described with reference to FIG. 10-18 to the tool or for fixating the first or second engaging arrangement directly to the shaft.

The torsion spring tensioning tool 100 thus further comprises a latching mechanism 400 with a latching pin 410. The latching pin 410 is adapted to selectively fixate the torsion spring tensioning tool 100 relative to the shaft to prevent movement of the spring tensioning tool 100 relative to the shaft to prevent movement of the spring tensioning tool in at least one direction. This may be achieved by means of the latching pin 410 being operable to selective engage a corresponding groove. The corresponding groove may be a corresponding groove provided on the shaft or on the adapter unit.

The latching mechanism allows for locking the tool in place relative the axial and/or radial direction of the counterbalancing shaft during tensioning, making the process of tensioning safer and more reliable.

In one embodiment, the corresponding engaging member of the shaft of the counterbalancing mechanism may accordingly be in the form a corresponding groove, the latching pin 410 being adapted to engage said groove.

The latching pin 410 may be spring-loaded to be biased against a corresponding groove for fixating the torsion spring tensioning tool 100 relative to the shaft in said at least one direction.

The latching pin 410 may be spring-loaded to be biased against a corresponding groove. Accordingly, the latching mechanism may comprise a spring mounted to said latching pin 410.

The latching pin 410 may extend along a latch axis. The latching mechanism 400 may further comprise a latch housing 411. The latching pin 410 may be movably arranged in said latch housing 411. The latching pin 410 may be connected to said latch housing 411 by means of the spring. The spring may be adapted to provide a biasing force onto the latching pin 410 extending along the latch axis LA. The biasing force may thus extend in a radial direction of the tool extending orthogonally to the axial direction of the shaft of the counterbalancing mechanism when the tool is mounted to said shaft. Accordingly, the latching pin 410 may extend in a radial direction of the tool.

The latch housing 411 may be fix relative to the gear wheel 21. The latch housing 411 may be mounted to the gear wheel 21. In one embodiment, the latch housing 411 may be mounted to the mounting plate 63. In one embodiment, the latch housing 411 may be mounted to the mounting plate 63 by means of fastening elements such as screws.

As depicted in FIG. 9, the latching mechanism 400 may comprise an engagement flange 415 and a cam structure 405. The engagement flange 415 is fix to, e.g. fixedly mounted to, the latching pin 410. The engagement flange 415 extends orthogonally to the latching pin 410.

The engagement flange 415 is in engagement with the cam structure 405. The engagement flange 415 is further spring-loaded, by means of being fixed to the spring loaded latching pin 410, to be biased, i.e. resiliently biased, against said cam structure 405 such that rotation of the engagement flange 415 causes movement of the latching pin 410 between an engaged position and a disengaged position.

In the engaged position, the latching pin 410 is positioned to engage the corresponding groove of the shaft. In the disengaged position, the latching pin 410 is positioned to disengage the corresponding groove of the shaft of the counterbalancing mechanism.

With the above-referenced latching mechanism a user may control the engagement between the tool and the shaft of the counterbalancing mechanism by rotating the engagement flange which allows for safer tensioning. It further allows for a more user-friendly manner of fixating the tool to the shaft of the counterbalancing mechanism.

The latching pin 410 may thus be movable relative the latch axis LA between said engaged and disengaged position. The latching pin 410 may be spring-loaded to be biased towards the engaged position. The latching pin 410 is movable by means of rotation of the engagement flange 415 about the latch axis LA.

The cam structure 405 may be formed on an annular sleeve. The latching pin 410 may extend through said annular sleeve. The cam structure 405 may be formed as at least a part of an annular surface of said annular sleeve. The annular surface faces and is in contact and engagement with a corresponding surface of the engagement flange 415.

The annular sleeve may thus have a cam structure 405 in the form of at least a portion of an outer annular surface.

As further depicted in FIG. 9, the cam structure 405 may include portions allowing for retention of the engagement flange 415. This enables securing of the latching pin in a safe position unless operation of said pin is required.

Accordingly, the cam structure 405 may comprise a disengagement retention groove 409 and/or an engagement retention groove 408. The disengagement retention groove 409 is adapted to receive and retain the engagement flange 415, i.e. a portion of the retention flange, in a position corresponding to the disengaged position of the latching pin 410. The engagement retention groove 408 is adapted to receive and retain the engagement flange 415, i.e. a portion of the retention flange, in a position corresponding to the engaged position of the latching pin 410.

The cam structure 405 may be formed as an at least partially annular surface, whereby the engagement retention groove 408 may be arranged at a first side of the annular surface and the disengagement retention groove is arranged at a second opposite side of the annular surface.

In operation, during fixation of the tool to the shaft, the latching pin 410 may be lifted out of engagement with the disengagement retention groove 409 by means of rotation of the engagement flange 415 about the latching axis LA. Upon rotation of the latching pin 410, the engagement flange 415 is rotated against the cam structure 405 due the latching pin 410 being spring loaded as the latching pin 410 moves towards its engaged position. Upon the latching pin 410 reaching its engaged position, the engagement flange 415 is moved to and retained in the engagement retention groove 408. To disengage the latching pin 410, the engagement flange 415 may be rotated out of engagement with the engagement retention groove 408 by means of rotation of the engagement flange 415 in an opposite direction. The engagement flange 415 may then be rotated against the cam structure 405 causing movement of latching pin 410 towards its disengaged position. Upon the latching pin 410 reaching its disengaged position, the engagement flange 415 is moved to and retained in the disengagement retention groove 409.

In one embodiment, the latching pin 410 may be detachable. The latching pin 410 may be detachable to allow for dismounting of said latching pin 410 from the second engaging arrangement. Thereby, the latching pin may be removed in order to ensure access to the during operation of the tool.

The housing 80 may be provided with means for receiving the latching pin 410 when the latching pin 410 has been detached. The housing 80 may be provided with a retention member 89. The retention member 89 is adapted to receive and retain the latching pin 410 when said latching pin 410 is dismounted from the second engaging arrangement 60.

In one embodiment, the retention member 89 may be provided as a hole, preferably a threaded hole. The hole may be adapted to receive the latching pin 410.

The latching pin 410 may be provided with threads to enable screwing of the latching pin 410 into the threaded hole.

In the embodiment depicted in FIGS. 1 to 9, the first engaging arrangement 32 is fix relative to the gear wheel 21 by means of being mounted to said gear wheel 21. Similarly, the second engaging arrangement 60 is fix relative to the gear wheel 21 by means of being mounted to said gear wheel 21. This allows for a tool without any adapters or movable parts, making the tool easy to use and reliable.

However, in some cases where the engaging arrangement needs to be utilized in tight spaces, there may be a need to adapt the tool accordingly. Hence, the torsion spring tensioning tool may be provided according to alternative embodiments. The alternative embodiments shares the features of the first embodiment depicted in FIGS. 1 to 9 with the exception of features which will be described with reference to FIGS. 10 to 18.

Said alternative embodiments involves an adapter unit on which one of the first or second engaging arrangement is provided. Hence, the first engaging arrangement 32 or the second engaging arrangement 60 may be provided on an adapter unit 31. The adapter unit 31 is releasably connectable to the gear wheel 21.

The adapter unit 31 may comprise a connection interface 96. The connection interface 96 is adapted to engage the other of the first or second engaging arrangement and thereby connect the adapter unit 31 to the gear wheel 21.

In one embodiment, the first engaging arrangement 32 is provided on the adapter unit 31. The adapter unit 31 comprises a connection interface 96. The connection interface 96 is adapted to engage the second engaging arrangement 60 and thereby connect the adapter unit 31 to the gear wheel 21.

In one embodiment, the second engaging arrangement 60 is provided on the adapter unit 31. The adapter unit 31 comprises a connection interface 96. The connection interface 96 is adapted to engage the first engaging arrangement 32 and thereby connect the adapter unit 31 to the gear wheel 21.

Referencing FIG. 10 to 13, the first engaging arrangement 32 may be provided on an adapter unit 31. The adapter unit 31 allows for dismounting and mounting of the first engaging arrangement based on the current need for use of first engaging arrangement.

The first engaging arrangement 32 may as described with reference to FIGS. 1 to 9, comprise a plurality of engaging members in the form of pins.

FIGS. 13 and 14 depicts the adapter unit 31 in further detail. The adapter unit 31 comprises a connection interface 96. The connection interface 96 may be adapted to engage the second engaging arrangement 60. Thereby, the adapter unit 31 is connected to the gear wheel 21. This may be performed such that the first engaging arrangement 32 becomes at least rotationally fix relative to the gear wheel 21, i.e. such that the first engaging arrangement 32 can transmit a rotational movement from the gear wheel 21 to the torsion spring of the first type of counterbalancing mechanism.

Preferably, the connection interface 96 comprises one or more connection splines 97. The one or more connection splines 97 may be adapted to engage the engaging members 61 of the second engaging arrangement 60. Hence, the one or more connection splines 97 may be adapted to engage the at least one cogged surface of the second engaging arrangement 60.

Advantageously, the one or more connection splines 97 and the engaging members 61 of the second engaging arrangement 60 may be axially extending, i.e. adapted to extend parallel with the shaft of the counterbalancing mechanism when the tool is mounted to said shaft of the counterbalancing mechanism.

The adapter unit 31 may comprise a flange 33. The flange 33 may extend axially. The flange 33 may extend substantially parallel to the shaft when the adapter unit 31 is mounted to the shaft. The flange 33 may thus be adapted to accommodate the circumference of the shaft. The flange 33 may formed as an annular flange or a section of an annular flange. The plurality of splines 97 may be provided on a surface of the flange 33 facing the second engaging arrangement, i.e. the engaging members 61 of the second engaging arrangement 60. Preferably, said surface of the flange 33 may be a radially outwardly facing surface, whereby the engaging members 61 of the second engaging arrangement are radially inwardly facing such is achieved between the connection splines 97 and said engaging members 33.

In one embodiment, the connection interface 96 and the second engaging arrangement 60 are adapted to be in sliding engagement. The adapter unit 31 may thus be slidable along the second engaging arrangement 60.

Referencing back to FIG. 10-12, the latching mechanism 400 previously described with reference to FIG. 1-9 may be utilized to lock the adapter unit 31 into engagement with the second engaging arrangement 60 or the first engaging arrangement 32. The latching pin 410 may hence be adapted to selectively fixate the adapter unit 31 relative to the gear wheel 21 in at least one direction by engaging a corresponding groove provided on the adapter unit 31.

In the embodiments depicted in FIG. 10-15, the latching mechanism 400 may be adapted to releasably fixate the second engaging arrangement 60 and the connection interface 96.

In one embodiment, the latching pin 410 is adapted to releasably engage the adapter unit 31 to releasably fixate the second engaging arrangement 60 and the connection interface 96.

The adapter unit 31 may thus comprise a corresponding groove with which the latching pin 410 may selectively engage. The corresponding groove may be in the form of the groove 39 depicted in FIG. 15. Upon engaging the groove 39, the adapter unit 31 is fixated to the second engaging arrangement in an axial direction (extending parallel to the shaft.

In an alternative embodiment, the latching mechanism may comprise an additional latching member adapted to engage the adapter unit 31 in addition to the latching pin 410.

It is recognized that the connection interface 96 and the engaging members 61 may be designed in any other manner suitable for allowing engagement.

As depicted in FIG. 13 (and FIG. 16) which depicts an additional embodiment of a torsion spring tensioning tool, a torsion spring tensioning tool kit may be provided. The torsion spring tensioning tool kit comprise a torsion spring tensioning tool. Although only depicted herein in combination with the embodiments of the tool of FIGS. 13 and 16 it may be envisioned that the kit may comprise any embodiment of the tool described herein.

The torque tensioning tool kit comprises a mounting bracket 400. The mounting bracket 400 is adapted to releasably hold the torsion spring tensioning tool 100. The mounting bracket allows for easy storage and transportation of the tensioning tool. Preferably, the torsion spring tensioning tool rests in the mounting bracket 400 with the housing 80 resting on the mounting bracket 400.

The mounting bracket 400 may comprise a mounting arrangement. The mounting arrangement is adapted to be releasably connected to a structure for mounting the mounting bracket 400 to said structure. Said structure is preferably a wall or a floor, for example in a vehicle transporting the tool.

The mounting bracket 400 may be provided with an adapter unit mount 410. The adapter unit mount 410 is adapted to releasably hold the adapter unit 31 when the adapter unit 31 is disconnected from the gear wheel 21. Thereby, the adapter unit may be moved out of the way when not required and can be transported in a simple manner.

Referencing FIG. 16, the second engaging arrangement 60 may be provided on an adapter unit 31. The adapter unit 31 allows for dismounting and mounting of the second engaging arrangement based on the current need for use of the second engaging arrangement.

The second engaging arrangement 60 may as described with reference to FIGS. 1 to 9, comprise a plurality of engaging members adapted to engage a second corresponding engagement interface associated with a second type of shaft and counterbalancing mechanism. The plurality of engaging members may form at least one cogged surface.

FIG. 17 depicts the adapter unit 31 in further detail. The adapter unit 31 comprises a connection interface 96. The connection interface 96 may be adapted to engage the first engaging arrangement 32. Thereby, the adapter unit 31 is connected to the gear wheel 21. This may be performed such that the second engaging arrangement 60 becomes at least rotationally fix relative to the gear wheel 21, i.e. such that the second engaging arrangement 60 can transmit a rotational movement from the gear wheel 21 to the torsion spring of the second type of counterbalancing mechanism.

Preferably, the connection interface 96 comprises one or more connection recesses 99. The one or more connection recesses may be adapted to engage the engaging members 41, 42, 43 of the first engaging arrangement 32. Hence, the one or more connection recesses 99 may be adapted to engage the one or more movable pins 41, 42 of the first engaging arrangement 32. Preferably a first connection recess may be adapted to engage a first movable pin and a second connection recess may be adapted to engage a second movable pin.

Advantageously, the one or more connection recesses 97 and the engaging members 41, 42, 43 of the first engaging arrangement 32 may be radially extending, i.e. adapted to extend perpendicular to the shaft of the counterbalancing mechanism when the tool is mounted to said shaft of the counterbalancing mechanism. Hence, the movable pins may be aligned with the connection recesses 97 and moved in a radial direction into the connection recesses in order to connect the first engaging arrangement and the adapter unit 31.

As described with reference to FIG. 8, the second engaging arrangement 60 comprises a partial ring gear rim 62. Preferably, the adapter unit 31 has an open channel for allowing easy mounting of the adapter unit 31 to the shaft. Each end of the adapter unit 31 facing the open channel may be provided with a connection flange 88. The connection flanges 88 may be joinable by means of a movable locking member 67. In order to increase the robustness of the adapter unit 31 the connection flanges may be joined together by means of the movable locking member 67 after mounting to the shaft. Preferably the movable locking member 67 is removed prior to mounting of the adapter unit 31 to the shaft in order to allow for proper alignment between the shaft and the adapter unit 31 in a simple manner.

The connection interface 96 may be provided on an outer surface of the adapter unit 31. The outer surface may extend substantially parallel to the shaft when the adapter unit 31 is mounted to the shaft. The outer surface may formed as an annular surface extending parallel and preferably coaxially to the outer surface of the shaft. The plurality of connection recesses may be provided on said outer surface, the outer surface facing the first engaging arrangement, i.e. the engaging members of the first engaging arrangement 32. Preferably, said outer surface may be a radially outwardly facing surface, whereby the engaging members of the first engaging arrangement 32 are radially inwardly facing such that connection is achieved between the connection recesses 99 and said engaging members 33. The connection recesses 99 may thus extend inwardly in a radial direction.

The latching mechanism 400 previously described with reference to FIG. 1-9 may be utilized to lock the adapter unit 31 into engagement with the first engaging arrangement 32 or the shaft.

In one embodiment, the latching mechanism 400 may be adapted to releasably fixate the first engaging arrangement 32 and the connection interface 96.

In one embodiment, the latching pin 410 is adapted to releasably engage the adapter unit 31 to releasably fixate the first engaging arrangement 32 and the connection interface 96.

In one embodiment, the latching mechanism 400 may be adapted to releasably fixate the second engaging arrangement and the shaft relative to each other in at least one direction.

In one embodiment, the latching pin 410 is adapted to releasably engage the the shaft to releasably fixate the second engaging arrangement 60 and the shaft, e.g. the engagement interface of the shaft.

In an alternative embodiment, the latching mechanism may comprise an additional latching member adapted to engage the adapter unit 31 in addition to the latching pin 410.

It is recognized that the connection interface 96 and the engaging members may be designed in any other manner suitable for allowing engagement.

FIGS. 18a-b depicts views of a mounting bracket for a torsion spring tensioning tool in further detail.

The mounting bracket 400 comprises the mounting arrangement 420. The mounting arrangement 420 may be provided with means for mounting to a structure for mounting the mounting bracket to said structure. In the depicted embodiment, the mounting arrangement 420 comprises a first mounting member 421 and a second mounting member 422. The first mounting member 421 is adapted to be mounted to a vertical surface of a structure (such as a wall). The second mounting member 422 is adapted to be mounted to a horizontal surface of a structure (such as a floor). The mounting arrangement may comprise one or more holes 423 extending through the first mounting member 421 and/or second mounting member 422 for receiving fastening means such as screws for mounting to the structure. It may however be envisioned that other types of means readily available for the skilled person may be provided on the mounting arrangement for mounting to the structure.

As depicted in FIGS. 18a-b, the adapter unit mount 410 may comprise a flange 41. The adapter unit 31 may be connectable to said flange by means of fastening elements such as screws. Hence, one or more holes may be provided in the flange 412 for receiving said fastening elements for fastening the adapter unit 31.

A counterbalancing mechanism is usually used in overhead sectional doors. Thus, the overhead door may be an overhead sectional door.

The mounting, operation and removal of the torsion spring tensioning tool 100 according to one embodiment is hereinafter described.

The tensioning tool 100 may be mounted on a shaft of a counterbalancing mechanism and connected to a torsion spring in the following way.

The first or second engaging arrangement 32, 60 is brought into engagement with the corresponding engagement interface of the shaft of the overhead door, thereby engaging the winding cone of the counterbalancing mechanism. This may be performed by means of passing said engaging arrangement into engagement with said corresponding engagement interface via the open end of the housing 80. The engaging arrangement 32, 60 is brought into engagement by a radial motion relative the shaft of the overhead door.

In the case of the first engaging arrangement 32 being provided on the adapter unit 31 in accordance with the embodiment described with reference to FIGS. 10-14, the adapter unit 31 is brought into engagement with the shaft. Hence, the first engaging interface 32 provided on the adapter unit 31 is brought into engagement with the corresponding engagement interface of the shaft. The second engaging interface 60 is aligned with and brought into engagement with the connection interface 96. Preferably, this is achieved by a sliding relative motion between the second engaging interface 60 and the connection interface 96.

Upon alignment and engagement being achieved, the second engaging interface 60 and the adapter unit 31 are locked into position relative each other. This may be achieved by means of the latching mechanism 400.

In the case of the second engaging arrangement 60 being provided on the adapter unit 31 in accordance with the embodiment described with reference to FIG. 16-17, the adapter unit 31 is brought into engagement with the shaft. Hence, the second engaging interface 60 provided on the adapter unit 31 is brought into engagement with the corresponding engagement interface of the shaft. The first engaging interface 32 is aligned with and brought into engagement with the connection interface 96. Preferably, this achieved by radially moving the one or more movable pins into engagement with the corresponding one or more connection recesses 99 of the connection interface 96.

Upon alignment and engagement being achieved, the first engaging interface 32 and the adapter unit 31 are locked into position relative each other. This may be achieved by means of the latching mechanism 400.

The tensioning tool 100 may be operated to tension the torsion spring of the counterbalancing mechanism in the following way. A screw gun is connected to the torque receiving arrangement 200, e.g. the driven member 201 of the torque receiving arrangement 200 such that rotation of the screw gun rotates the rotation member 55. The rotation member 55 rotates the plurality of cogged wheels 51, 52 in turn rotating the gear wheel 21. The plurality of cogged wheels 51, 52 may rotate the gear wheel 21 at an even lower rotational speed and the transferred torque is even higher. The rotation of the gear wheel 21 is transferred to the winding cone via the engaging arrangement 32, 60 fix relative to the gear wheel 21. Thereby, the torsion spring is wound. To tension the torsion spring, the direction of rotation of the screw gun is chosen such that the torsion spring is wound up. It is easily realized that the tensioning tool can be used to relax the tension of the torsion spring by operating the screw gun in the opposite direction.

When suitable tension of the torsion spring has been achieved, the winding cone is rotationally locked to the shaft of the counterbalancing mechanism by tightening of tightening screws arranged in the winding cone and engaging the shaft and/or by inserting a key in a key groove formed in the shaft and the winding cone.

The tensioning tool 100 can be removed from the counterbalancing mechanism in different ways depending on whether the first or second engaging arrangement is utilized to engage the shaft.

In the case of the first engaging arrangement, the pins may be disengaged from the corresponding holes in the winding cone by means of turning or pulling of the pins, thereby allowing the engaging arrangement to disengage by moving the tool in a radial direction (relative the shaft).

In the case of the second engaging arrangement, the tool may be moved in parallel to the shaft, whereby the cogged surface disengages the splines of the winding cone and the tool can be removed via movement in a radial direction (relative the shaft). If the second engaging arrangement further includes the latching pin, this has to be disengaged from the groove of the winding cone first.

It should be appreciated that even though numerous characteristics and advantages of the present invention have been set forth in the foregoing description, together with details of the structure and function of the invention, the description is only illustrative and changes may be made in detail, especially in matters of shape, size and arrangement of parts within the scope of the invention to the full extent indicated by the appended claims.

1. Torsion spring tensioning tool (100) for tensioning a torsion spring of a counterbalancing mechanism of an overhead door, wherein the torsion spring tensioning tool (100) comprises a housing (80) and a gear wheel arrangement (20) adapted to be mounted on a shaft of the counterbalancing mechanism, said gear wheel arrangement (20) comprising a gear wheel (21) rotatably arranged in the housing (80), the torsion spring tensioning tool (100) further comprising a gear mechanism (54) coupled to the gear wheel (21) for rotating said gear wheel (21),
wherein the gear wheel arrangement (20) comprises a first engaging arrangement (32) and a second engaging arrangement (60) each being arranged to be fixed relative to the gear wheel (21),
wherein the first engaging arrangement (32) is adapted to engage a first corresponding engagement interface associated with a first type of shaft and counterbalancing mechanism and transmit a rotational movement from the gear wheel (21) to the torsion spring of said first type of counterbalancing mechanism, and
wherein the second engaging arrangement (60) is adapted to engage a second corresponding engagement interface associated with a second type of shaft and counterbalancing mechanism and transmit a rotational movement from the gear wheel (21) to the torsion spring of said second type of counterbalancing mechanism.

2. The torsion spring tensioning tool (100) according to claim 1, wherein the gear mechanism (54) comprises a plurality of cogged wheels (51, 52) engaging the gear wheel (21).

3. The torsion spring tensioning tool (100) according to claim 2, wherein the plurality of cogged wheels (51, 52) are distributed along the circumference of the gear wheel (21).

4. The torsion spring tensioning tool (100) according to claim 2, wherein the plurality of cogged wheels (51, 52) comprises a first cogged wheel (51) and a second cogged wheel (52) arranged on opposite sides of the gear wheel (21) relative a rotation axis of the gear wheel (21).

5. The torsion spring tensioning tool (100) according to claim 1, wherein first and second engaging arrangement (32, 60) are coaxially arranged.

6. The torsion spring tensioning tool (100) according to claim 1, wherein the gear wheel (21) is formed as a partial ring wheel and the housing (80) has an open end such that the first or second engaging arrangement (32, 60) can be brought into engagement with the first or second corresponding engagement interfaces, respectively, from a direction extending orthogonally to the shaft.

7. The torsion spring tensioning tool (100) according to claim 1, wherein first and second engaging arrangement (32, 60) each comprises a plurality of engaging members (41, 42, 43, 61) adapted to engage a set of corresponding engagement members of the first and second corresponding engagement interface, respectively.

8. The torsion spring tensioning tool (100) according to claim 7, wherein the plurality of engaging members (41, 42, 43) of the first engaging arrangement comprises one or more movable pins (41, 42).

9. The torsion spring tensioning tool (100) according to claim 8, wherein the plurality of engaging members (41, 42, 43) of the first engaging arrangement comprises an adjustable pin or a fix pin (43) and at least one retractable pin (41, 42).

10. The torsion spring tensioning tool (100) according to claim 7, wherein the plurality of engaging members (61) of the second engaging arrangement (60) forms at least one cogged surface adapted to engage corresponding splines of the second corresponding engagement interface.

11. The torsion spring tensioning tool (100) according to claim 10, wherein the at least one cogged surface forms a partial ring gear rim.

12. The torsion spring tensioning tool (100) according to claim 1, further comprising a latching mechanism (400) with a latching pin (410) adapted to selectively fixate the torsion spring tensioning tool (100) relative to the shaft to prevent movement of the spring tensioning tool (100) in at least one direction.

13. The torsion spring tensioning tool (100) according to claim 12, wherein the latching pin (410) is detachable to allow for dismounting of said latching pin (410) from the second engaging arrangement (60).

14. The torsion spring tensioning tool (100) according to claim 13, wherein the housing (80) is provided with a retention member (89) adapted to receive and retain the latching pin (410) when said latching pin (410) is dismounted from the second engaging arrangement (60).

15. The torsion spring tensioning tool (100) according to claim 12, wherein the latching pin (410) is spring-loaded to be biased against a corresponding groove for fixating the torsion spring tensioning tool (100) relative to the shaft in the at least one direction.

16. The torsion spring tensioning tool (100) according to claim 1, further comprising a handle (75) coupled to the housing (80).

17. The torsion spring tensioning tool (100) according to claim 1, wherein the gear mechanism (54) comprises a torque receiving arrangement (200), the torque receiving arrangement (200) comprising a driven member (201) adapted to engage a driving member of an external drive unit for transfer of torque to the gear (21).

18. The torsion spring tensioning tool (100) according to claim 17, wherein the torque receiving arrangement (200) is provided as a worm gear mechanism.

19. The torsion spring tensioning tool (100) according to claim 1, wherein the first engaging arrangement (32) or the second engaging arrangement (60) is provided on an adapter unit (31), the adapter unit (31) being releasably connectable to the gear wheel (21).

20. The torsion spring tensioning tool (100) according to claim 19, wherein the first engaging arrangement (32) or the second engaging arrangement (60) is provided on the adapter unit (31) and the adapter unit (31) comprises a connection interface (96), wherein said connection interface (96) is adapted to engage the other of the first or second engaging arrangement (32, 60) and thereby connect the adapter unit (31) to the gear wheel (21).

21. The torsion spring tensioning tool (100) according to claim 20, wherein the plurality of engaging members of the second engaging arrangement forms at least one cogged surface adapted to engage corresponding splines of the second corresponding engagement interface and
wherein the first engaging arrangement (32) is provided on the adapter unit (31) and the connection interface (96) comprises one or more connection splines (97) adapted to engage the at least one cogged surface of the second engaging arrangement (60).

22. The torsion spring tensioning tool (100) according to claim 20, wherein first and second engaging arrangement each comprises a plurality of engaging members adapted to engage a set of corresponding engagement members of the first and second corresponding engagement interface, respectively, wherein the plurality of engaging members of the first engaging arrangement comprises one or more movable pins, and
wherein the second engaging arrangement (60) is provided on the adapter unit (31) and the connection interface (96) comprises one or more connection recesses (99) adapted to engage the one or more movable pins (41, 42).

23. The torsion spring tensioning tool (100) according to claim 19, further comprising a latching mechanism with a latching pin adapted to selectively fixate the torsion spring tensioning tool relative to the shaft to prevent movement of the spring tensioning tool in at least one direction,
wherein the latching pin (410) is adapted to selectively fixate the adapter unit (31) relative to the gear wheel (21) in the at least one direction by engaging a corresponding groove provided on the adapter unit (31).

24. The torsion spring tensioning tool (100) according to claim 1, wherein each of the first engaging arrangement (32) and the second engaging arrangement (60) is fix relative to the gear wheel (21) by means of being mounted to said gear wheel (21).

25. A torsion spring tensioning tool kit comprising a torsion spring tensioning tool (100) according to claim 1 and a mounting bracket (400) adapted to releasably hold the torsion spring tensioning tool (100).

26. The torsion spring tensioning tool kit according to claim 25, wherein the mounting bracket (400) comprises a mounting arrangement (420) adapted to be releasably connected to a structure for mounting the mounting bracket (400) to said structure.

27. The torsion spring tensioning tool kit according to claim 25, wherein the first engaging arrangement or the second engaging arrangement is provided on an adapter unit, the adapter unit being releasably connectable to the gear wheel, wherein the mounting bracket (400) is provided with an adapter unit mount (410), wherein the adapter unit mount (410) is adapted to releasably hold the adapter unit (31) when said adapter unit (31) is disconnected from the gear wheel (21).
